(19) United States
(12) Patent Application Publication
(10) Pub. No.: US 2026/0234406 A1
(43) Pub. Date: Aug. 13, 2026

(54) BETALAIN COMPOSITIONS

(71) Applicant: GIVAUDAN SA, VERNIER (CH)

(72) Inventors: Raja CHOUKET, Avignon (FR); Hana BISHT KOCOURKOVA, Derbyshire (GB)

(21) Appl. No.: 19/475,266

(22) PCT Filed: Apr. 18, 2024
(86) PCT No.: PCT/EP2024/060553

§ 371 Date: Oct. 14, 2025

(30) Foreign Application Priority Data
Apr. 21, 2023 (EP) 23169204.7
Oct. 16, 2023 (GB) 2315800.9

(51) Int. Cl. C09B 67/20; A21D 2/14; A21D 2/22; A21D 2/36; A23L 5/43; A23L 13/40; C09B 61/00

(52) U.S. Cl. CPC C09B 67/0065; A21D 2/145; A21D 2/22; A21D 2/36; A23L 5/43; A23L 13/428; C09B 61/00

(57) ABSTRACT

The present invention is related to a dye composition comprising components A) and B), wherein A) is one or more dyes comprising a Betalain, specially a betanin and B) comprises one or more of citric acid, ascorbic acid, malic acid and ethylenediaminetetraacetic acid, and at least one salt, as well as the uses of said dye composition and final consumer products comprising said dye composition.

### TECHNICAL FIELD

The present disclosure relates to new dye formulations comprising one or more dyes comprising a betalain with an improved stability to heat conditions.

### BACKGROUND

Synthetic red dyes and particularly azo dyes like Allura Red AC (red dye 40), are commonly used in US market for food colouring thanks to their attractive cost, vibrant red colour and excellent stability to light, heat, oxygen, pH and low microbiological contamination. How-ever, these pigments have several side effects on health due to their toxicity.

This major health threat created a mounting pressure to find alternatives to these pigments, currently the most widespread red food colorants are carmine E120, anthocyanin (E163) and red beetroot (E162). However, these pigments suffer from a series of limitations.

Carmine is a bright red-pink colour pigment obtained from aluminium complex derived from carminic acid, this pigment is quite stable against light and heating which make it an attractive product in food industry. However, this pigment is extracted from an animal source (cochineal insect) which make it not vegan friendly product in addition this pigment is not fully natural since it's chemically modified (complexed with Aluminium).

Anthocyanins are unstable at pH>3, and do not give the targeted vibrant red shade which limits their use in dairy, bakery, and meat application where the pH ranges from 5.5 to 6.5.

Color is one of the most important organoleptic qualities of food products. Betanin, a natural water-soluble pigment providing a red color, is a safe and healthy food colorant. Betanin, which is the major constituent of betacyanin (75%-90%), is found mainly in beetroot, amaranth, and cactaceae plants such as dragon fruit, and is the source of the red-mauve color of these plants. However, environmental factors such as high temperature make betanin easily degrade and discolor, limiting its application range in the food industry. At present, there are many studies on the improvement of the stability of betanin, but most effective methods are through encapsulation systems such as microcapsules, liposomes and hydrogels. For example, the Chinese patent application number: CN202110616032.4, which discloses a preparation method of betanin microcapsules with composite wall materials, taking betanin solution as a core material and maltodextrin-rice protein-jerusalem artichoke polysaccharide mixed solution as the wall materials, pouring the core material into the mixed solution, forming the microcapsules by a method of adjusting pH, and freeze-drying the microcapsules into microcapsule powder.

Faced to these constraints manufacturers have been under pressure to find strong solutions to satisfy natural, vegan, halal and kosher consumers, thus the search for novel stabilization on natural compounds more specifically on beetroot extract is nowadays very active.

Several scientific papers and patents reported that ascorbic acid can improve the stability of beetroot extract. U.S. Pat. No. 4,132,793 introduced the use of ascorbic acid or iso-ascorbic acid to improve betanin stability. WO 2014/102304 reported also the use of acerola extract as natural source of ascorbic acid.

Another stabilizing effect using EDTA was reported in Herbach, K. M., Stintzing, F. C. and Carle, R. (2006), Betalain Stability and Degradation—Structural and Chromatic Aspects. Journal of Food Science, 71: R41-R50) And in Castro-Enríquez, D. D., Montaño-Leyva, B., Del Toro-Sanchez, C. L. et al. Stabilization of betalains by encapsulation—a review. J Food Sci Technol 57, 1587-1600 (2020). https://doi.org/10.1007/s13197-019-04120. Despite all these attempts, there is still a need to improve effectively the stability of betanin.

To overcome this limited performance, we introduce new red beet formulation that minimise major degradation reactions that cause strong colour deviation such as hydrolysis reaction of betalain leading to Betalamic acid (yellow) and cyclo-Dopa 5-O-b-glucoside and oxidation dehydrogenation leading to Neobetanin (yellow).

### FIGURES

FIG. 1. Evaluation of color after heat treatment of samples 1A and 1B.

FIG. 2. Picture of cakes after backing with the inventive formulation (2F) compared to control formulations (2A-2E).

FIG. 3. Evaluation of color after heat treatment of samples 3A to 3F.

FIG. 4. Evaluation of the regeneration of the color of the inventive formulation after heat treatment compared to control samples.

FIG. 5. Formulation 2 incorporated in snack recipe

FIG. 6. New stable beetroot (6A) is redder (higher a values of a) than 6B (standard beetroot) after extrusion at different temperatures.

FIG. 7. Color measurements of cooked ham right after opening. L*

FIG. 8. Color measurements of cooked ham right after opening. a*,

FIG. 9. Color measurements of cooked ham right after opening. b*.

### SUMMARY

The inventors of the present invention have developed a new dye formulation that minimize colour deviation of the dye comprising a Betalain, specially a betanin, when subjected to thermal treatment.

As demonstrated in examples 1, 2 and 3, the formulations of the invention surprisingly provide a protection of the color of the dyes comprising a Betalain, specially a betanin red color, in consumer products even after thermal treatment (backing).

Surprisingly, it was also observed that consumer products containing the formulations of the invention, even if after thermal treatment a deviation of the red color was observed, a reversion of this color lost to the original red color was achieved (see example 5).

In a first illustrative aspect, provided is a dye composition comprising components A) and B), wherein A) is one or more dyes comprising a Betalain, specially a betanin and B) comprises one or more of citric acid, ascorbic acid, malic acid and ethylenediaminetetraacetic acid, and at least one salt. In certain embodiments, the at least one salt is a salt of the one or more acids (citric acid, ascorbic acid, malic acid and ethylenediaminetetraacetic acid).

In a second illustrative aspect, provided is a dye composition comprising components A) and B), wherein A) is one or more dyes comprising a Betalain, specially a betanin and B) comprises citric acid and ascorbic acid, and at least one salt. In certain embodiments, the at least one salt is selected from citric acid salts and/or ascorbic acid salts.

Those compositions will be named in the present disclosure as the “composition” or “compositions” of the invention.

According to a third illustrative aspect, provided is a method for thermally stabilize a dye comprising Betalains, specially betaninz, comprising the steps of
i. providing one or more dyes comprising a Betalain, specially a betanin
ii. providing one or more of citric acid, ascorbic acid, malic acid and/or ethylenediaminetetraacetic acid, and at least one salt, specially a salt of the one or more acids,
iii. mixing the ingredients.

According to a further illustrative aspect, provided is a method for thermally stabilize a dye comprising Betalains, specially betanin comprising the steps of
i. providing one or more dyes comprising a Betalain, specially a betanin
ii. providing citric acid and ascorbic acid, and at least one salt, specially a salt of citric acid and/or ascorbic acid
iii. mixing the ingredients.

According to another illustrative aspect, provided is a kit comprising one or more of: a dye comprising Betalains, citric acid, ascorbic acid, and at least one salt, and optionally instructions on how to mix, prepare and/or use said ingredients.

According to another illustrative aspect, provided is a kit comprising one or more of: a dye comprising Betalains, one or more of citric acid, ascorbic acid, malic acid and/or ethylenediaminetetraacetic acid, and at least one salt, specially a salt of the one or more acids

According to another illustrative aspect, provided is a consumable, a pharmaceutical, a cosmeceutical, a nutraceutical or cosmetic product comprising a dye composition according to the invention or the components of the kit according to the invention.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature.

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

The term “colour” refers to the colour properties such as hue, chroma, purity, saturation, intensity, vividness, value, lightness, brightness and darkness, and colour model system parameters used to describe these properties, such as Commission Internationale de l'Eclairage CIE 1976 CIELAB colour space L*a*b* values.

The term “hue” refers to the colour property that gives a colour its name, for example, red, blue and brown.

When a concentration is expressed as “ppm”, the concentration is parts per million by weight based on the total weight of the consumable. It should be understood that when a range of values is described in the present disclosure, it is intended that any and every value within the range, including the end points, is to be considered as having been disclosed. For example, “a range of from 1 ppm to 1000 ppm” of a component of the composition is to be read as indicating each and every possible number along the continuum between 1 and 1000. It is to be understood that the inventors appreciate and understand that any and all values within the range are to be considered to have been specified, and that the inventors have possession of the entire range and all the values within the range.

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

The details, examples and preferences provided in relation to any one or more of the stated aspects or embodiments of the present invention will be further described herein and apply equally to all aspects and embodiments of the present invention. Any combination of embodiments, examples and preferences described herein below in all possible variations thereof are encompassed by the present invention unless otherwise indicated herein, or otherwise clearly contradicted by context.

The present invention is related to a dye composition comprising components A) and B), wherein A) is one or more dyes comprising a Betalain, specially a betanin and B) comprises one or more of citric acid, ascorbic acid, malic acid, and ethylenediaminetetraacetic acid, and at least one salt. In certain embodiments, the at least one salt is a salt of the one or more acids (citric acid, ascorbic acid, malic acid and ethylenediaminetetraacetic acid). In certain embodiments, the dye composition of the invention is stable to heat.

The component B comprises one or more of acids selected from citric acid, ascorbic acid, malic acid, and ethylenediaminetetraacetic acid and at least one salt. Thus, the component B may comprise for example one, two, 3 or 4 acids, and any combinations of said acids:
citric acid and ascorbic acid,
citric acid and malic acid,
citric and ethylenediaminetetraacetic acid
ascorbic acid and malic acid
ascorbic acid and ethylenediaminetetraacetic acid
ascorbic acid and malic acid and ethylenediaminetetraacetic acid,
ascorbic acid and malic acid and citric acid, etc

Component B also comprises at least one salt. The at least one salt may be any salt that is food grade. In certain preferred embodiments, the at least one salt used is a salt of the one or more acids present in component B. That is, the at least one salt is a salt of an acid selected from citric acid, ascorbic acid, malic acid and/or ethylenediaminetetraacetic acid. In certain more preferred embodiments, the at least one salt used in component B is a salt of the acid or acids used in component B. For example, if citric acid and ascorbic acid are used, the at least one salt may be a salt of citric acid and/or a salt of ascorbic acid.

In certain preferred embodiments, the acids used are citric acid and ascorbic acid.

In certain preferred embodiments, the acids used are citric acid and ascorbic acid and the salt is one or more salts from citric acid and/or ascorbic acid.

Thus, in one embodiment, the present invention is related to a dye composition comprising components A) and B), wherein A) is one or more dyes comprising a Betalain, specially a betanin, and B) comprises citric acid and ascorbic acid, and at least one salt. In certain embodiments the at least one salt is a salt of citric acid and/or ascorbic acid. In certain embodiments, the dye composition of the invention is stable to heat.

In one embodiment, the present invention is related to a dye composition stable to heat comprising components A) and B), wherein A) is one or more dyes comprising a Betalain, specially a betanin and B) comprises one or more of citric acid, ascorbic acid, malic acid, and ethylenediaminetetraacetic acid, and at least one salt of the one or more of said acids.

In one embodiment, the present invention is related to a dye composition stable to heat comprising components A) and B), wherein A) is one or more dyes comprising a Betalain, specially a betanin and B) comprises citric acid and ascorbic acid, and at least one salt. In certain embodiments the at least one salt is a salt of said acids (citric acid and/or ascorbic acid)

Those compositions will be named, interchangeable, in the present disclosure as the “composition”, “dye composition”, “compositions” or “dye compositions” of the invention.

### Betalains

Betalains are a class of red and yellow tyrosine-derived pigments found in plants of the order Caryophyllales, where they replace anthocyanin pigments. There are two categories of betalains:
a) Betacyanins, which appear reddish to violet. Examples of betacyanins present in plants include betanin, isobetanin, probetanin, and neobetanin; and
b) Betaxanthins, which appear yellow to orange. Betaxanthins present in plants include vulgaxanthin, miraxanthin, portulaxanthin, and indicaxanthin.

Therefore, the betalains used in the present invention may be betacyanins (such as betanin, isobetanin, probetanin, and neobetanin), betaxanthins (such as vulgaxanthin, miraxanthin, portulaxanthin, and indicaxanthin) or mixtures thereof.

Betalains are glycosides of a betanidin aglycone, whose core structure is betalamic acid (i.e. 4-(2-oxoethylidene)-1,2,3,4-tetrahydropyridine-2,6-dicarboxylic acid).

Betanin is usually obtained from the extract of the juice of Beta vulgaris (red beets, beetroot).

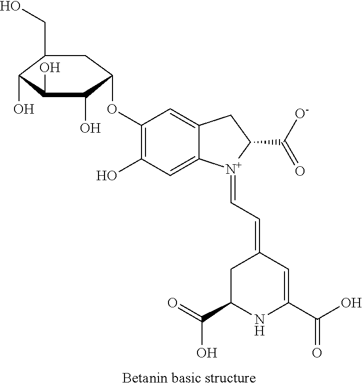

In certain embodiments of the dye composition of the invention, component A) comprises a dye comprising a betanin.

In certain embodiments component A) comprises a dye comprising a betanin and one or more of isobetanin, probetanin, neobetanin, vulgaxanthin, miraxanthin, portulaxanthin, and indicaxanthin. In certain embodiments, the component A has a red color.

Betacyanins (such as betanin, isobetanin, probetanin, and neobetanin) and betaxanthins (such as vulgaxanthin, miraxanthin, portulaxanthin, and indicaxanthin) may be obtained from different parts of plants such as the leaves, the fruits, the roots, the tuber or the stems.

In certain embodiments, the pigments comprising a Betacyanins (such as betanin, isobetanin, probetanin, and neobetanin) and/or a betaxanthins (such as vulgaxanthin, miraxanthin, portulaxanthin, and indicaxanthin) may be produced via fermentation using microorganism such as bacteria, fungus or yeast.

In certain embodiments of the dye composition of the invention, the pigments comprising a Betacyanins (such as betanin, isobetanin, probetanin, and neobetanin) and/or a betaxanthins (such as vulgaxanthin, miraxanthin, portulaxanthin, and indicaxanthin) may be obtained from beet roots (Beta vulgaris L.), amaranth (Amaranthus sp.), pitahaya, Opuntia sp., Eulychnia sp. and Hylocereus sp., dragon fruits of mainly Hylocereus polyrhizus, colored Swiss chard (B. vulgaris L. ssp. cicla), Celosia argentea L., Bougainvillea sp. ulluco (Ullucus tuberosus Caldas) or bloodberries (berries of Rivina humilis L.) or mixtures thereof.

In certain embodiments component A) comprises one or more plant extracts and/or plant concentrates obtained or obtainable from one or more of: beet roots (Beta vulgaris L.), amaranth (Amaranthus sp.), pitahaya, Opuntia sp., Eulychnia sp. and Hylocereus sp., dragon fruits of mainly Hylocereus polyrhizus, colored Swiss chard (B. vulgaris L. ssp. cicla), Celosia argentea L., Bougainvillea sp. ulluco (Ullucus tuberosus Caldas) or bloodberries (berries of Rivina humilis L.) and/or pigments comprising a betanin produced via microorganism such as bacteria, fungus or yeast.

In certain embodiments, the pigment component A) comprises a betanin and can be obtained, for example, from the red beet and/or from opuntia. It is preferably used as a plant concentrate which is obtained by squeezing out the red beet and/or the opuntia and subsequently drying.

The color intensity of the constituents of component (A) is defined as follows. The color intensity of the plant extracts and plant concentrates of component (A) is the absorbance determined by an E1% absorbance measurement at a pH of 5 and a wavelength of 535 nm. Betanin-containing plant extracts and plant concentrates having an extinction value E1% in a range from 3 to 50 are preferred here.

Natural dyes and components used which have these color intensities generally have, in addition to an adequate color intensity, other particularly favorable coloring properties, for example with respect to hue, color brilliance, etc., and in particular with respect to color strength and hiding power.

In certain embodiments of the dye composition of the invention, the component A) will provide an initial colour hue of h (340-350). In certain embodiments of the dye composition of the invention, the component A will provide a red or reddish color, and thus the final color of the composition of the invention is red or reddish color.

In certain embodiments of the dye composition of the invention, the one or more dyes comprising a Betalain comprises at least 1% w/w of a Betalain, such as at least 2% w/w, at least 3% w/w, at least 4% w/w, at least 5% w/w, at least 6% w/w, at least 7% w/w, at least 8% w/w, at least 9% w/w, at least 10% w/w, at least 11% w/w, at least 12% w/w, at least 13% w/w, at least 14% w/w, at least 15% w/w, at least 16% w/w, at least 17% w/w, at least 18% w/w, at least 19% w/w, at least 20% w/w, at least 25% w/w, at least 30% w/w, at least 35% w/w, at least 4% w/w, at least 45% w/w, at least 50% w/w of a Betalain in respect to the total weight of the dye.

In certain preferred embodiments, the dye comprises a betanin, such as one or more betanin obtained from beet root.

In certain embodiments, the one or more dyes comprising a betanin comprises at least 1% w/w of a betanin, such as at least 2% w/w, at least 3% w/w, at least 4% w/w, at least 5% w/w, at least 6% w/w, at least 7% w/w, at least 8% w/w, at least 9% w/w, at least 10% w/w, at least 11% w/w, at least 12% w/w, at least 13% w/w, at least 14% w/w, at least 15% w/w, at least 16% w/w, at least 17% w/w, at least 18% w/w, at least 19% w/w, at least 20% w/w, at least 25% w/w, at least 30% w/w, at least 35% w/w, at least 4% w/w, at least 45% w/w, at least 50% w/w of a betanin in respect to the total weight of the dye. In certain embodiments, the dye comprising a betanin is a plant concentrate from beet root.

The component B) of the compositions of the invention comprises one or more of acids selected from citric acid, ascorbic acid, malic acid, and ethylenediaminetetraacetic acid and at least one salt. Thus, the component B may comprise for example one, two, 3 or 4 acids, and any combinations of said acids, such as:
citric acid and ascorbic acid,
citric acid and malic acid,
citric and ethylenediaminetetraacetic acid
ascorbic acid and malic acid
ascorbic acid and ethylenediaminetetraacetic acid
ascorbic acid and malic acid and ethylenediaminetetraacetic acid,
ascorbic acid and malic acid and citric acid, etc

Component B also comprises at least one salt. The at least one salt may be any salt that is food grade. In certain preferred embodiments, the salt used is at least one salt used is a salt of the one or more acids present in component B. That is, the at least one salt is a salt of an acid selected (citric acid, ascorbic acid, malic acid and/or ethylenediaminetetraacetic acid). In certain more preferred embodiments, the at least one salt used in component B is a salt of the acid or acids used in component B. For example, if citric acid and ascorbic acid are used, the at least one salt may be a salt of citric acid and/or a salt of ascorbic acid.

In certain preferred embodiments of the dye composition of the invention, Component B) comprises citric acid and ascorbic acid, and at least one salt. In a preferred embodiment, the at least one salt is a salt of citric acid and/or ascorbic acid.

The citric acid, ascorbic acid, malic acid and ethylenediaminetetraacetic acid and the least one salt, specially the at least one salt of any of said acids may be of natural or synthetic origin or any mixtures thereof.

In certain embodiments the citric acid used in the present invention has a purity of at least 5%, such as at least 10%, 20%, 30%, 40%, 50%, 60%, 70%, 80%, 90%, 95% or 99% by weight. In certain embodiments, the citric acid may be obtained or be obtainable from a fruit from a citrus (such as lemons, lime, etc).

In certain embodiments the ascorbic acid used in the present invention has a purity of at least 5%, such as at least 10%, 20%, 30%, 40%, 50%, 60%, 70%, 80%, 90%, 95% or 99% by weight.

In certain embodiments, the ascorbic acid may be obtained or be obtainable from acerola (Malpighia emarginata DC), citrus fruits, any other natural source rich in ascorbic acid and any mixtures thereof.

In certain embodiments the malic acid used in the present invention has a purity of at least 5%, such as at least 10%, 20%, 30%, 40%, 50%, 60%, 70%, 80%, 90%, 95% or 99% by weight.

In certain embodiments the ethylenediaminetetraacetic acid used in the present invention has a purity of at least 5%, such as at least 10%, 20%, 30%, 40%, 50%, 60%, 70%, 80%, 90%, 95% or 99% by weight.

In certain embodiments the at least one salt (such as a salt of citric acid, a salt of ascorbic acid, a salt of malic acid and/or a salt of ethylenediaminetetraacetic acid) used in the present invention has a purity of at least 5%, such as at least 10%, 20%, 30%, 40%, 50%, 60%, 70%, 80%, 90%, 95% or 99% by weight.

In certain embodiments, the at least one salt is selected from any citrate salts know in the art (such as potassium citrate, potassium-sodium citrate and potassium-magnesium citrate), any ascorbate salts know in the art (such as sodium ascorbate, calcium ascorbate, potassium ascorbate, magnesium ascorbate), any malic acid salts know in the art (such as sodium malate, calcium malate, potassium malate, magnesium malate or any ethylenediaminetetraacetic acid salts know the in art (such as sodium ethylenediaminetetraacetate, calcium ethylenediaminetetraacetate, potassium ethylenediaminetetraacetate, magnesium ethylenediaminetetraacetate), and any mixtures thereof.

In certain embodiments, the at least one salt is selected from citrate salts (such as potassium citrate, potassium-sodium citrate and potassium-magnesium citrate), ascorbate salts (such as sodium ascorbate, calcium ascorbate, potassium ascorbate, magnesium ascorbate) and any mixtures thereof.

In certain embodiments the weight ratio of the at least one betalain (such as a betanin) and component B is of from about 0.1:50 to about 50:0.1, such as from about 0.5, 1, 5, 10, 15, 20, 25, 30, 35, 40, 45 to (:) about 50, 45, 40, 35, 30, 25, 20, 15, 10, 5, 1, 05, 0.1; such as from about 1:30 to 30:1, such as from about 0.5:30 to about 2:35, such as about 1:30.

In certain embodiments, 2 acids are used and the weight ratio of the first acid to the second acid (for example citric acid to ascorbic acid) is of from about 0.5:30 to about 30:0.5, such as from 0.5, 1, 5, 10, 15, 20, 25, 30 to (:) 25, 20, 15, 10, 5, 1, 0.5, such as from about 1:25 to about 25:1, such as from about 0.5:25 to about 2:25, such as about 1.20.

In certain embodiments, the weight ratio of citric acid to ascorbic acid is of from about 0.5:30 to about 30:0.5, such as from 0.5, 1, 5, 10, 15, 20, 25, 30 to (:) 25, 20, 15, 10, 5, 1, 0.5, such as from about 1:25 to about 25:1, such as from about 0.5:25 to about 2:25, such as about 1.20.

In certain embodiments, the weight the ratio of the one or more acids to the at least one salt is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments citric acid is use, and the weight the ratio of citric acid to the at least one salt (for example one or more of citric acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments ascorbic acid is use, and the weight the ratio of ascorbic acid to the at least one salt (for example one or more of ascorbic acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments malic acid is use, and the weight the ratio of ascorbic acid to the at least one salt (for example one or more of malic acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments ethylenediaminetetraacetic acid is use, and the weight the ratio of ascorbic acid to the at least one salt (for example one or more of ethylenediaminetetraacetic acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments combinations of 2 acids are used, and the weight the ratio of said 2 acids to the at least one salt (for example one or more salts of one or more of those 2 acids) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

For example, in certain embodiments citric acid and ascorbic acid is use, and the weight the ratio of the acids to the at least one salt (for example one or more of citric acid salts and/or ascorbic acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In other embodiments ascorbic acid and malic acid is use, and the weight the ratio of the acids to the at least one salt (for example one or more of ascorbic acid salts and/or malic acid salts) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments combinations of 3 acids are used, and the weight the ratio of said 3 acids to the at least one salt (for example one or more salts of one or more of those 3 acids) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments combinations of 4 acids are used, and the weight the ratio of said 3 acids to the at least one salt (for example one or more salts of one or more of those 4 acids) is of from about 0.5:10 to about 10:0.5, such as from 0.5, 1, 2, 3, 4, 5, 6, 7, 8, 9 to (:) 10, 9, 8, 7, 6, 5, 4, 3, 2, 1, 0.5, such as from about 1:5 to about 5:1, such as from about 0.5:2 to about 2:1, such as about 1:2.

In certain embodiments, B is citric acid, ascorbic acid and sodium citrate.

In certain embodiments, the weight ratio between citric acid, ascorbic acid and sodium citrate is about 1:2:10, such as about 0.5:2:10, such as about 2:2:10, such as about 1:1:10, such as about 1:3:10, such as about 1:2:9, such as about 1:2:11.

In certain embodiments, (A) is present in an amount of from about 1 to about 99% by weight, such as in an amount of from about 2 to about 10% by weight, preferably from about 2 to about 5% by weight and (B) is present in an amount of from about 1 to about 99% by weight, such as in an amount of from about 10 to about 40% by weight, preferably in an amount of from about 25 to about 35%, such as about 32% by weight of the final composition. In certain embodiments, A) comprises an amount of Betalains, specially betanin of from about 0.5 to about 99% w/w by weight, preferably an amount of from about 1 to about 30% w/w by weight.

In certain embodiments, the composition of the invention comprises an amount of betanin from 1 w/w to 30% w/w by weight, preferably 5 w/w to 10% w/w by weight of the final composition.

In certain embodiments the dye composition of the invention comprises from about 1% to 30% w/w of beetroot (comprising from 10% w/w betanin to about 30% w/w betanin, such as 15% w/w betanin), from about 10% to about 65% w/w ascorbic acid, from about 1% to about 15% citric acid and from 3% to about 15% w/w sodium citrate, optionally the rest being a carrier.

In certain embodiments the dye composition of the invention comprises from about 10% to 25% w/w, such as about 16% w/w of beetroot (from 10% w/w betanin to about 30% w/w betanin, such as 15% w/w betanin), from about 55% to about 65% w/w such as about 60% w/w ascorbic acid, from about 4% to about 7% such as 6% w/w citric acid and from 10% to about 15% w/w such as 12% w/w sodium citrate.

The dye composition according to the invention may be presented as a solid or as a liquid.

The dye composition according to the invention may be formulated as a composition which additionally contains a component (C) or carrier selected from the group consisting of arabic gum, dextrose, salt, mono & diglycerides of fatty acids, MPG, Polysorbate 80, dextrose, vegetable oil, glucose syrup, glycerin, decaglycerol monooleate, fatty acid esters, benzyl alcohol, ethyl alcohol, propylene, glycol, polysorbates, sorbitans, sorbitan trioleate, capric/caprylic triglycer-ides, dextrose, maltodextrin, guar gum, trehalose, alginate, starches and modified starch, sucrose, dextran, inulin, whey protein isolate, potato protein isolate, xanthan gum, pectin, soy protein, chitosan, gelatin, soluble fiber such as beta-d-glucan, pullulan and combinations thereof. In a preferred embodiment, the carrier is polysorbate 80.

In certain embodiments, the ratio between the composition of the invention and the carrier may be from 1:99 to 99:1, such as from 10:90 to 90:10, such as from 10:90 to 30:70. As the person skilled in the art would know, the concentration of the carrier may be adapted to the final use of the dye. Thus if a high concentrated dye is required, less carrier would be use while when less concentrated dye is required more carrier can be used.

In a preferred embodiment, the composition is in dry form. In another embodiment, the com-position may be in a liquid form.

In certain embodiments the composition of the invention is suitable for human consumption.

### Methods

The invention is also related to a dye composition according to the invention, prepared by a process comprising the steps of
i. providing a component (A),
ii. providing a component (B),
iii. optionally providing a component (C),
iv. Mixing the ingredients.

The ingredients (A), (B) as described herein previously and optionally (C) may be mixed in any order and using any method well known in the art. The different components (A), (B) and optionally (C) may be mixed in a solid form or a liquid form.

In another aspect, the invention is related to a method for obtaining a thermally stable dye comprising Betalains, specially betanin, comprising the steps of
i. providing one or more dyes comprising a Betalain, specially a betanin
ii. providing one or more of citric acid, ascorbic acid, malic acid and/or ethylenediaminetetraacetic acid, and at least one salt, specially a salt of the one or more acids,
iii. mixing the ingredients.

In certain preferred embodiments, the component (B) is citric acid and ascorbic acid, and at least one salt, especially at least one salt of citric acid and/or ascorbic acid.

Thus, in another aspect, the invention is related to a method for obtaining a thermally stable dye comprising a Betalain, specially a betanin comprising the steps of:
i. providing (A) one or more dyes comprising a Betalain, specially a betanin
ii. providing (B) citric acid and ascorbic acid, and at least one salt,
iii. mixing the ingredients.

In certain embodiments, the methods of the invention for obtaining thermally stable dye comprising a Betalain of the invention, may additionally comprise further mixing a compound C). In certain embodiment, component C is selected from gum arabic, maltodextrin, guar gum, trehalose, alginate, starches and modified starch, sucrose, dextran, inulin, whey protein isolate, potato protein isolate, xanthan gum, pectin, soy protein, chitosan, gelatin, soluble fiber such as beta-d-glucan, pullulan or mixtures thereof.

The ingredients (A), (B) and optionally (C) may be mixed in any order and using any method well known in the art. The different components (A), (B) and optionally (C) may be mixed in a solid form or a liquid form.

The dye comprising a Betalain stable to heat obtained by this method may be in a solid or a liquid form.

The dye composition according to the invention may be presented as a solid or as a liquid.

The dye composition according to the invention may be formulated as a composition which additionally contains a carrier as described before. For example, said carrier may be selected from the group consisting of arabic gum, dextrose, salt, mono & diglycerides of fatty acids, MPG, Polysorbate 80, dextrose, vegetable oil, glucose syrup, glycerin, decaglycerol monooleate, fatty acid esters, benzyl alcohol, ethyl alcohol, propylene, glycol, polysorbates, sorbitans, sorbitan trioleate, capric/caprylic triglycer-ides, dextrose and combinations thereof. In a preferred embodiment, the composition is in dry form. In another embodiment, the com-position may be in a liquid form.

In the present invention, the term “stable to heat” means that the color hue provided by the dye composition of the invention comprising components A) and B), is not changed or has a change of less than 30% in respect to the color hue measured before the heat treatment, such as less than 20%, such as less than 10%, such as less than 5% of color hue change. In the present invention “stable to heat” also means that even if the color hue may change after heat treatment, there is a reversion to the original color hue. Thus the end color can be considered as not to be changed.

Thus, in certain embodiments, the color provided by the dye composition of the invention (such as a red color) is stable after a thermal treatment of more than 40° C., such as a treatment of more than 50° C., 60° C., 70° C., 80° C., such as more than 90° C., more than 100° C., more than 110° C., more than 120° C., 130° C., 140° C., 150° C., 160° C., 170° C., 180° C., 190° C. or more than 200° C. for a period at least 30 seconds, at least 1 minute, at least 5 minutes, at least 10 minutes, at least 30 minutes, at least 1 hours, at least 2 hours, such as at least 5 hours.

In certain embodiments of the dye composition of the invention, the betalain (specially betanin) is stable after a thermal treatment of more than 40° C., such as a treatment of more than 50° C., 60° C., 70° C., 80° C., such as more than 90° C., more than 100° C., more than 110° C., more than 120° C., 130° C., 140° C., 150° C., 160° C., 170° C., 180° C., 190° C. or more than 200° C. for a period at least 30 seconds, at least 1 minute, at least 5 minutes, at least 10 minutes, at least 30 minutes, at least 1 hours, at least 2 hours, such as at least 5 hours.

In certain embodiments, the dye composition of the invention is stable after a heating process such as any heating method available in the art and used to produce for example food and beverage products.

In certain embodiments, the dye composition of the invention is stable after one or more of an extrusion process, after a cooking process, a backing process, a pressurization process, frying process, and any other heating method available in the art and used to produce food and beverage products.

In certain embodiments, the color provided by the dye composition of the invention (such as a red color) is stable after one or more of an extrusion process, after a cooking process, a backing process, a pressurization process, frying process, and any other heating method available in the art and used to produce food and beverage products.

In certain embodiments, the dye composition of the invention is stable after one or more of an extrusion process, after a cooking process, a backing process, a pressurization process, frying process, and any other heating method available in the art and used to produce food and beverage products.

In certain embodiments, the color provided by the dye composition of the invention (such as a red color) is stable after one or more of an extrusion process, after a cooking process, a backing process, a pressurization process, frying process, and any other heating method available in the art and used to produce food and beverage products.

### Kit

The present invention also relates to a kit comprising the different elements of the dye composition of the invention separately i.e. component A, component B and optionally component C as described previously herein, and optionally instructions on how to mix, prepare and/or use said ingredients. In certain embodiments, the kit comprises the elements already mixed and ready to use (for example as a blend) and optionally instructions of how to use said ingredients. In certain embodiments, the kit comprises other colors such as yellow or red colors.

### Uses and Products

The present invention is also related to a consumable, a cosmetic or a pharmaceutical or nutraceutical preparation comprising a stabilized dye composition of the invention or a kit of the invention.

In one aspect, use of a stabilized dye composition of the invention as described before in colouring a food product is provided. The dye composition of the present invention can be added to a food product in an amount effective to increase, enhance and/or modify the colour characteristics of a food product or portion thereof. The components of the kit of the present invention can be added to a food product in an amount effective to increase, enhance and/or modify the colour characteristics of a food product or portion thereof.

A method for obtaining a stabilized color of a consumable, a pharmaceutical, a cosmeceutical, a nutraceutical or cosmetic product comprising adding to a consumable, a pharmaceutical, a cosmeceutical, a nutraceutical or cosmetic product base a composition according to the invention or the components of kit the invention.

Food encompasses the following general food categories, as defined by the Food and Drug Administration (FDA): baked goods and baking mixes, including all ready-to-eat and ready-to-bake products, already backed products like patisserie and cakes, flours, and mixes requiring preparation before serving; beverages, alcoholic, including malt beverages, wines, distilled liquors, and cocktail mix; beverages and beverage bases, non-alcoholic, including only special or spiced teas, soft drinks, coffee substitutes, and fruit and vegetable flavored gelatin drinks; breakfast cereals, including ready-to-eat and instant and regular hot cereals; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavored frosting, marshmallows, baking chocolate, and brown, lump, rock, maple, powdered, and raw sugars; dairy product analogs, including nondairy milk, frozen or liquid creamers, coffee whiteners, toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh fruits and fruit juices, including only raw fruits, citrus, melons, and berries, and home-prepared “ades” and punches made therefrom; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; fresh vegetables, tomatoes, and potatoes, including only fresh and home-prepared vegetables; frozen dairy desserts and mixes, including ice cream, ice milks, sherbets, and other frozen dairy desserts and specialties; fruit and water ices, including all frozen fruit and water ices; gelatins, puddings, and fillings, including flavored gelatin desserts, puddings, custards, parfaits, pie fillings, and gelatin base salads; grain products and pastas, including macaroni and noodle products, rice dishes, and frozen multicourse meals, without meat or vegetables; gravies and sauces, including all meat sauces and gravies, and tomato, milk, buttery, and specialty sauces; hard candy and cough drops, including all hard type candies; herbs, seeds, spices, seasonings, blends, extracts, and flavorings, including all natural and artificial spices, blends, and flavors; jams and jellies, home-prepared, including only home-prepared jams, jellies, fruit butters, preserves, and sweet spreads; jams and jellies, commercial, including only commercially processed jams, jellies, fruit butters, preserves, and sweet spreads; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavored milks and milk drinks, dry milks, toppings, snack dips, spreads, weight control milk beverages, and other milk origin products; nuts and nut products, including whole or shelled tree nuts, peanuts, coconut, and nut and peanut spreads; plant protein products, including the National Academy of Sciences/National Research Council “reconstituted vegetable protein” category, and meat, poultry, and fish substitutes, analogs, and extender products made from plant proteins; poultry products, including all poultry and poultry-containing dishes, salads, appetizers, frozen multicourse poultry meals, and sandwich ingredients prepared by commercial processing or using commercially processed poultry with home preparation; processed fruits and fruit juices, including all commercially processed fruits, citrus, berries, and mixtures; salads, juices and juice punches, concentrates, dilution, “ades”, and drink substitutes made therefrom; processed vegetables and vegetable juices, including all commercially processed vegetables, vegetable dishes, frozen multicourse vegetable meals, and vegetable juices and blends; snack foods, including chips, pretzels, and other novelty snacks; soft candy, including candy bars, chocolates, fudge, mints, and other chewy or nougat candies; soups, home-prepared, including meat, fish, poultry, vegetable, and combination home-prepared soups; soups and soup mixes, including commercially prepared meat, fish, poultry, vegetable, and combination soups and soup mixes; sugar, white, granulated, including only white granulated sugar; sugar substitutes, including granulated, liquid, and tablet sugar substitutes; and sweet sauces, toppings, and syrups, including chocolate, berry, fruit, corn syrup, and maple sweet sauces and toppings.

For example, the food colouring composition as described hereinbefore can be used to impart a stable red color similar to the colour obtained when using Allura Red AC (red dye 40) or carmine E120 (artificial color) to food products, such as dairy, confectionery, beverages, sauces/gravies, etc.

A dairy product may refer to yogurt, custard, milk smoothie, milk shake, dairy ice cream.

A confectionery product may refer to a sweet or candy food product, such as chewing gums or hard and soft confectionery products. Non-limiting examples of confectionery products include cakes, cookies, pies, chocolates, chewing gums, gelatins, ice creams, puddings, jams, jellies, gummies, hard boiled candies, chewy candies, cereal and other breakfast foods, canned fruits and fruit sauces.

A beverage product may refer to beverages, beverage mixes and concentrates, including but not limited to alcoholic and non-alcoholic ready to drink and dry powdered beverages. Non-limiting examples of beverages can include carbonated and non-carbonated beverages, e.g., sodas, fruit or vegetable juices.

A sauce product may refer to a sweet or savoury semi-solid composition used to add flavour, moisture and/or visual appeal to a dish. Non-limiting examples of sauces include gravy and barbecue sauce.

A meat analogue product may refer to foods made from vegetarian ingredients, which approximate certain aesthetic qualities (such as texture, flavour, appearance) or chemical characteristics of specific types of meat. Non-limiting examples of meat analogues include vegetable (veggie) burgers.

In yet another aspect, it is provided a food product comprising stabilized dye composition of the invention as described hereinbefore. For example, the food product may be as described above.

One of ordinary skill in this art will recognize that the optimal amount of food colour composition present in a given food product is determined by factors such as overall desired colour, solubility, regulatory approval, etc. One of ordinary skill in this art can readily determine the optimal amount of colour for a given product based on those factors.

The inventors of the present invention, have surprisingly found that the dye composition of the invention has a very high heat stability even at high moisture contains.

In certain embodiments, the product (a consumable such as a food or beverage product, a pharmaceutical, a cosmeceutical, a nutraceutical or cosmetic product) comprising the dye composition of the invention has a low moisture content. Low moisture content in the present invention means less than 10% w/w water in the final product.

In certain embodiments, the product (a consumable such as a food or beverage product, a pharmaceutical, a cosmeceutical, a nutraceutical or cosmetic product) comprising the dye composition of the invention has a medium moisture content. Medium moisture content in the present invention means between 10% w/w and 50% w/w water in the final product.

In certain embodiments, the product (a consumable such as a food or beverage product, a pharmaceutical, a cosmeceutical, a nutraceutical or cosmetic product) comprising the dye composition of the invention has a high moisture content. High moisture content in the present invention means more than 50% w/w water in the final product.

The present invention is related to a consumable, a pharmaceutical, a cosmeceutical, a nutraceutical or cosmetic product comprising the dye of the invention, wherein the product is treated with a heating process and the color provided by the dye composition of the invention is stable after said heating process. Heating process or thermal treatment are interchangeable in the present invention.

In certain embodiments, the color provided by the dye composition of the invention (such as a red color) is stable in the product (a consumable such as a food or beverage product, a pharmaceutical, a cosmeceutical, a nutraceutical or cosmetic product) after a thermal treatment of more than 40° C., such as a treatment of more than 50° C., 60° C., 70° C., 80° C., such as more than 90° C., more than 100° C., more than 110° C., more than 120° C., 130° C., 140° C., 150° C., 160° C., 170° C., 180° C., 190° C. or more than 200° C. for a period at least 30 seconds, at least 1 minute, at least 5 minutes, at least 10 minutes, at least 30 minutes, at least 1 hours, at least 2 hours, such as at least 5 hours.

In certain embodiments the colour of the product (a consumable such as a food or beverage product, a pharmaceutical, a cosmeceutical, a nutraceutical or cosmetic product) comprising the dye composition of the invention, is stable after a thermal treatment of more than 40° C., such as a treatment of more than 50° C., 60° C., 70° C., 80° C., such as more than 90° C., more than 100° C., more than 110° C., more than 120° C., 130° C., 140° C., 150° C., 160° C., 170° C., 180° C., 190° C. or more than 200° C. for a period at least 30 seconds, at least 1 minute, at least 5 minutes, at least 10 minutes, at least 30 minutes, at least 1 hours, at least 2 hours, such as at least 5 hours.

In certain embodiments, the colour of the product (a consumable such as a food or beverage product, a pharmaceutical, a cosmeceutical, a nutraceutical or cosmetic product) comprising the dye composition of the invention, is stable after a thermal treatment selected form one or more of an extrusion process, after a cooking process, a backing process, a pressurization process, frying process, and any other heating method available in the art and used to produce for example food and beverage products.

In certain embodiments, the product is a food product, such as a sweet good, a cake, a biscuit etc that was backed at least 100° C.

In certain embodiments, the product is a food product is a snack that was first cooked, backed and/or pressurized at a temperature of at least 100° C. and then fried, for example at high temperature such as more than 190° C., such as 200° C. In one aspect, use of a stabilized dye composition of the invention as described before in colouring a pharmaceutical, cosmeceutical, nutraceutical or cosmetic product is provided. The stabilized dye composition of the invention can be added to the product (pharmaceutical, nutraceutical or cosmetic product) in an amount effective to increase, enhance and/or modify the colour characteristics of the product or a portion thereof, for example to provide a bright stable red color.

In another aspect, the invention relates to a pharmaceutical composition, cosmeceutical, a nutraceutical or to a cosmetic composition comprising a stabilized dye composition of the invention as defined in the present document and, optionally a vehicle adequate for the formulation of said stabilized dye composition of the invention into said pharmaceutical composition, cosmeceutical or cosmetic composition. The stabilized dye composition of the invention would provide a desired color (such as a stable red color) to said pharmaceutical, cosmeceutical, cosmetic or nutraceutical formulation.

“Pharmaceutical composition”, as used herein, relates to compositions and molecular entities that are physiologically tolerable. Preferably, the term “pharmaceutically acceptable” means it is approved by a regulatory agency of a state or federal government or is included in the U.S. Pharmacopoeia or other generally recognized pharmacopoeia for use in animals, and more particularly in humans.

“Cosmetic composition”, as used herein refers to a composition suitable for use in personal hygiene of human beings or animals, or in order to enhance the natural beauty or change the body appearance without affecting the structure or functions of the human or animal body, comprising one or more products providing such effects. If desired, the cosmetic composition provided by the invention can contain, in addition to the composition of the invention, one or more cosmetics or cosmetic products, i.e., substances or mixtures intended to be placed in contact with the external parts of the human or animal body (e.g., epidermis, hair system, nails, lips, etc.) or with the teeth and the buccal mucosa, for the exclusive or main purpose of cleaning them, perfuming them, changing their appearance, protecting them, keeping them in good condition or correcting body odors. Illustrative examples of cosmetically acceptable vehicles include the products contained in the INCI (International Nomenclature of Cosmetic Ingredients) list. The composition of the present invention may be added to a wide variety of products for cosmetic application, including makeup, creams for cleansing, protecting, treating, or caring for the skin, in particular, the face, hands, and feet (e.g., day and night creams, makeup removal creams, foundation creams and sunscreens), liquid foundations, makeup removal lotions, protective or skin-care body lotions, sunscreen lotions, skin care lotions, gels, or foams, such as cleansing, sunscreen, and artificial tanning lotions, bath preparations, deodorant compositions, after-shave gels or lotions, depilatory creams, and compositions used for insect stings and against pain. The composition of the invention may take any of a wide variety of forms, and include, for example dressings, lotions, solutions, sprays, creams, gels, ointments, or the like.

In certain embodiments, the composition of the invention or the kit of the invention may be used to prepare color cosmetics or make-up. Color cosmetics or make up encompasses different categories of products for skin, eyes, cheeks and lips, such as face make-up, such as foundation, blushers, illuminators, face bronzing lotions, creams and powders, loose and pressed powders, and mineral powders; eye make-up, such as eye shadows, eyeliners, eyebrow pencils, kohl and mascara, and mineral powders; lip make-up, such as lipstick, lip glosses, lip pencils, lip plumpers, pots and palettes; and nail make-up, such as nail varnishes and polishes, hardeners and strengtheners, base and top coat.

In certain embodiments, the composition of the invention or the kit of the invention may be used encapsulated with a clay such as montmorillonite. WO2021191243A1, incorporate here by reference, described the use of micronized montmorillonite to prepare an encapsulated natural dye for color cosmetics.

In certain embodiments, the composition of the invention or the kit of the invention may be used directly as dye (such as a red dye) for cosmetic application for coloring cosmetic formulas such as shower gel, shampoo, lotion, cream etc.

As used herein, the term “cosmeceutical product” refers to a product suitable for use in the body or animal body comprising one or more cosmeceutical products (functional cosmetics, dermaceuticals or active cosmetics), i.e., topical hybrid products with cosmetic-pharmaceutical characteristics containing active ingredients having effect on user's skin, hair and/or nails, at higher and more effective concentrations, therefore they are located in an intermediate level between cosmetic and drug. Illustrative examples of cosmeceutical products include essential oils, ceramides, enzymes, minerals, peptides, vitamins, etc.

As used herein, the term “nutraceutical product” refers to a product suitable for use in human beings or animals, comprising one or more natural products with therapeutic action which provide a health benefit or have been associated with disease prevention or reduction, and it includes dietary supplements presented in a non-food matrix (e.g., capsules, powder, etc.) of a concentrated natural bioactive product usually present (or not) in the foods and which, when taken in a dose higher than that existing in those foods, exerts a favorable effect on health which is greater than effect which the normal food may have. Therefore, the term “nutraceutical product” includes isolated or purified food products as well as additives or food supplements which are generally presented in dosage forms normally used orally, for example, capsules, tablets, sachets, drinkable phials, etc.; such products provide a physiological benefit or protection against diseases, generally against chronic diseases. If desired, the nutraceutical product provided by the invention can contain, in addition to the composition of the invention, one or more nutraceuticals (products or substances associated with disease prevention or reduction), for example, flavonoids, omega-3 fatty acids, etc., and/or one or more prebiotics (non-digestible food ingredients which stimulate probiotic activity and/or growth), for example, oligofructose, pectin, inulin, galacto-oligosaccharides, lactulose, human milk oligosaccharides, dietary fiber, etc.

In certain embodiments, the product (consumable or food product, pharmaceutical, cosmeceutical, nutraceutical or cosmetic product) has a pH ranging from 2.8 to 7

In certain embodiments, the product (consumable or food product, pharmaceutical, cosmeceutical, nutraceutical or cosmetic product) has being treated to a thermal treatment and/or is exposure to light.

The inventors of the present invention, have surprisingly found that the addition of a dye composition according to the invention to a product (consumable or food product, pharmaceutical, cosmeceutical, nutraceutical or cosmetic product) stabilizes the color of the dye present in the composition of the invention even if said product is heated. Also, surprisingly, even if a certain color lost occurs after the heating, the presence of the components of the composition of the invention provides a recovery of the color hue of the dye present in the composition of the invention to the color hues that the product had before the thermal treatment (see example 4).

In certain embodiments the consumable, pharmaceutical, cosmeceutical, nutraceutical or cosmetic product according to the invention was submitted to a thermal treatment and further packaged in the presence of water.

The inventors of the present invention have surprisingly found that the present dye composition of the invention provides a pink or red color similar in meat products similar to the color that have meat products treated with nitrites and/or nitrates. The use of natural colors in cooked meats is not easy because most of the natural colors are not stable to heat or certain pH conditions.

The present invention is also directed to the use of a stabilized dye composition of the invention as described herein in colouring a meat food product wherein the meat products shows a cured color without the use of nitrites. In certain embodiments the color is a pink or a red color. In certain embodiments, the red or pink color is similar to the one obtained in the same product when Nitrites are used.

In certain embodiments, the color obtained using the dye composition of the invention (i.e. red or pink color) is stable to heat and/or stable to low pH.

In certain embodiments the dye composition of the invention comprises from about 15% to 25% w/w, such as about 20% of beetroot (5% betanin), from about 55% to about 65% w/w such as about 60% w/w ascorbic acid, from about 4% to about 7% such as 6% w/w citric acid and from 10% to about 15% w/w such as 12% w/w sodium citrate.

In certain embodiments, the food product (such as a meat product) during the production was subjected to heating or cooking and/or has a pH of less than 6.

In certain embodiments, the product is a cooked meat product such as cooked ham or a sausage. The present invention is also related to a Curing Aid composition of the invention.

Curing Aid Composition of the invention

The present invention is related to a curing aid composition comprising (I) a dye composition comprising components A) and B), wherein A) is one or more dyes comprising a Betalain, specially a betanin and B) comprises one or more of citric acid, ascorbic acid, malic acid and ethylenediaminetetraacetic acid, and at least one salt and (II) one or more of antioxidants and/or one or more antimicrobials.

In certain embodiments, the antioxidant and/or antimicrobial is selected form one or more of a Lamiaceae extract (such as rosemary extract, sage extract), ascorbic acid (such as ascorbic acid form acerola), acetic acid (such as vinegar), green tea, organic acids, yeast extracts, pomegranate extract, Artichokes extract, Olive extract, green coffee extract, Camu camu juice or extract, rosehip extract etc.

The present invention is also directed to the use of a Curing aid as described herein comprising the stabilized dye composition of the invention as described herein in colouring a meat food product wherein the meat products shows a cured color without the use of nitrites. In certain embodiments the color is a pink or a red color. In certain embodiments, the red or pink color is similar to the one obtained in the same product when Nitrites are used.

In certain embodiments, the color obtained using the dye composition of the invention (i.e. red or pink color) is stable to heat and/or stable to low pH.

In certain embodiments, the food product (such as a meat product) during the production was subjected to heating or cooking and/or has a pH of less than 6.

In certain embodiments, the product is a cooked meat product such as cooked ham or a sausage.

The stabilized dye composition of the invention may be used together with lower quantities of Nitrites together with other antioxidant and/or antimicrobial products to confer the properties of a curing agent (red or pink color and antioxidant and antimicrobial protection) while using lower quantities of Nitrites.

For example, if normally a for curing a specific meat product a certain quantity of Nitrite is used, now, with the stabilized dye composition of the invention, the concentration of Nitrite can be reduced to more than 50%, more than 60%, more than 70% or more than 80% without losing the characteristic pink or red color of the Nitrite. Additionally, to obtain the antimicrobial effect of the Nitrites on the meat, further antioxidant and/or antimicrobials can be used together with the stabilized dye composition of the invention.

Therefore, the present invention also relates to a method of making a reduced Nitrite meat product that has the properties of a meat product that has been cured with Nitrites, comprising the step of adding (I) a dye composition of the invention comprising components A) and B), wherein A) is one or more dyes comprising a Betalain, specially a betanin and B) comprises one or more of citric acid, ascorbic acid, malic acid and ethylenediaminetetraacetic acid, and at least one salt and (II) one or more of food grade antioxidants and/or antimicrobials and optionally Nitrites. In certain embodiments, the concentration of Nitrite can be reduced to more than 50%, more than 60%, more than 70% or more than 80% of the normal quantity used to cure said food product without losing the characteristic pink or red color of the Nitrite and the antimicrobial properties.

The stabilized dye composition of the invention may be used together with antioxidant and/or antimicrobial products, to confer the properties of a curing agent without using Nitrites.

Therefore, the present invention also relates to a method of making a Nitrite-free meat product that has the properties of a meat product that has been cured with Nitrites, comprising the step of adding the curing aid of the invention comprising (I) a dye composition of the invention comprising components A) and B), wherein A) is one or more dyes comprising a Betalain, specially a betanin and B) comprises one or more of citric acid, ascorbic acid, malic acid and ethylenediaminetetraacetic acid, and at least one salt and (II) one or more of food grade antioxidants and/or antimicrobials, optionally without the addition of Nitrite and/or nitrate.

Food grade antioxidants and/or antimicrobials are known in the art and may be of natural or artificial origin.

In a preferred embodiment, the antioxidants and/or antimicrobials are of natural origin.

In certain embodiments, the food grade antioxidant and/or the antimicrobial can be selected from one or more of the ones cited by FSA such as: Lamiaceae extract (such as rosemary extract, sage extract), ascorbic acid (such as ascorbic acid form acerola), acetic acid (such as vinegar), green tea, organic acids, yeast extracts, pomegranate extract, Artichokes extract, Olive extract, green coffee extract etc.

As used herein, the term “Lamiaceae extract” may refer to an extract from a plant of the Lamiaceae family, including but not limited to rosemary, sage, oregano, thyme, mints, and the following genera: Salvia (such as Salvia apiana and Salvia officinalis), Rosmarinus (such as Rosmarinus officinalis), Lepechinia, Oreganum, Thymus, Hyssopus and any mixtures thereof.

The Lamiaceae material used for extracting the Lamiaceae extract can be any part of the plant such as leaves, roots, flowers, stems, etc. In a preferred embodiment, the part of the plant are the leaves and/or the stems.

The Lamiaceae material may be processed before extraction, for example it can be washed, dried, milled or grounded, etc.

The Lamiaceae extract (such as a rosemary and/or salvia extract) may be obtained or obtainable by the extraction of the aerial parts of a Lamiaceae extract (such as a rosemary and/or salvia extract) with acetone or ethanol (for example, aqueous ethanol) followed by optional purification depending on the concentration of the phenolic diterpene(s) required in the final extract.

Particular solvents and method of extractions to obtain extracts rich in phenolic diterpenes are known in the art. For example a detailed procedure to prepare a Rosemary extract was described in the U.S. Pat. No. 5,859,293 (PCT WO96/34534), which is incorporated herein by reference in its entirely.

As used herein, the term “Phenolic diterpenes” may refer to carnosic acid, carnosol, methylarsonate, and other phenolic diterpene derivatives (rosmanol, isorosmanol, 11, 12-di-O-methylisorosmanol, 12-O-methylcarnosic acid, rosmanol-9-ethyl ether, circumarctic, Methylated monooxidized product of carnosic acid, genkwanin, epirosmanol, epiisorosmanol, carnosic acid derivative, epirosmanol ethyl ether, cryptotanshinone) and mixtures thereof.

In some embodiment, the Lamiaceae extract (such as rosemary and/or salvia extract) comprises at least about 1%, at least about 2%, at least about 3%, at least about 4%, at least about 5%, at least about 6%, at least about 7%, at least about 8%, at least about 9%, at least about 10%, at least about 15%, at least about 20%, at least about 30%, at least about 40%, at least about 50%, at least about 60%, at least about 70%, at least about 80%, at least about 90%, at least about 95%, or at least about 99 wt % of one or more phenolic diterpenes such as the ones described before. In a preferred embodiment, the Lamiaceae extract(s) that may be used in the present invention comprises carnosic acid and/or carnosol.

In certain embodiments, the Lamiaceae extract (such as rosemary and/or salvia extract) may comprise (or consist essentially/consist of) the following phenolic diterpenes: carnosic acid and/or carnosol. In certain embodiments, the ratio between carnosic acid and carnosol is from 40:1 to 1:40, such as 30:1, 20:1, 10:1, 5:1 or 1:1.

In a particular embodiment, the Lamiaceae extract is an extract wherein a majority of the volatile oil components have been removed. As used herein, the term “volatile oil components” may refer to compounds like essential oils such as: (−)-borneol, (−)-bornyl acetate, (−)-camphor, 1,8-Cineole (eucalyptol) and verbenone.

In one embodiment the ration between the total % of phenolic diterpene(s) (such as carnosic acid and carnosol)/Total % of volatiles oil components (such as (−)-borneol, (−)-bornyl acetate, (−)-camphor, 1,8-Cineole (eucalyptol) and verbenone) is not less than 15.

As “ascorbic acid” in the present application is understood acide ascorbique and/or its salt, including but not limited to ascorbate de sodium, acide erythorbique and erythorbate de sodium. The ascorbic acid and its salts that may be used in the present invention may be of a natural or a synthetic origin. In a preferred embodiment, ascorbic acid and/or its salt is obtained from some natural source rich in ascorbic acid including but not limited to acerola (Malpighia glabra L.), citrus family (citrus genus) including but not limited to orange, lemon, calamansi, lime, kumquat, mandarin and grapefruit), etc. Also ascorbic acid and/or its salt obtained using fermentation methods are included herein. Ascorbic acid and/or its salt may be further purified to obtain highly concentrated ascorbic acid and/or its salt.

Thus, in certain embodiments, the curing aid composition of the invention comprises ascorbic acid form acerola (such as an acerola juice, dry juice, etc) and it may be present in the element (II) of the composition in an amount from about 1% to about 90% w/w, such as from about 2% w/w to about 50% w/w, such as from about 5% to about 30% w/w or about 9% or about 25% w/w. In certain embodiments, the acerola juice or dry juice is present from 5% to 10% and has as ascorbic contain of at least 30% w/w.

In certain embodiments, the compositions of the invention may comprise ascorbic acid in element (II) of the composition in an amount from about 0.1% to about 99.9%, such as from about from 1% w/w to 30% w/w, such as from 1% w/w to about 25% w/w, such as from about 1% w/w to 10%, such as from 2% w/w to about 10% w/w, such as 3%, 4% w/w, 5% w/w or about 9% w/W.

In certain embodiments, the acerola juice or dry juice may have a concentration of ascorbic acid of at least 10% w/w, such as at least 20%, at least 30%, such as at least 40% w/w.

The acerola juice may be dried using techniques known in the art to provide an ascorbic acid rich powder.

The acetic acid in the present invention includes acetic acids and any of its salt. The acetic acid may be present in element (II) of the composition in an amount from about 2% to about 99%, such as from about 2% w/w to about 90% w/w, such as from about 2% w/w to about 50% w/w, such as from about 3% w/w to about 30% w/w, 3% to about 20% w/w, such as from about 5% w/w to 20% w/w, such as about 10% w/w to about 30% w/w, such as about 10% w/w or such as about 20% w/w, or about 5% w/w, 17% w/w.

In certain embodiments, the acetic acid is from buffered vinegar and the concentration of acetic acid in element (II) of the composition is from 3% w/w to about 30% w/w, such as from 10 to 20% w/w such as 17% w/w.

In certain embodiments, the acetic acid is from non-buffered vinegar and the concentration of acetic acid in element (II) of the composition of the invention is from 2% w/w to about 20% w/w, such as from 2% to 10% w/w such as 5% w/w.

Any source of acetic acid may be use in the present invention, including but not limited to vinegar, non-buffered vinegar, buffered vinegar, concentrated vinegar, non-concentrated vinegar or any mixtures thereof. The vinegar includes but is not limited to white wine vinegar, champagne vinegar, rice vinegar, apple cider vinegar, raisin vinegar, apricot vinegar, sherry vinegar, malt vinegar, beer vinegar, red vinegar, red wine vinegar, balsamic vinegar or black vinegar). The vinegar may be concentrated or not. The vinegar may be buffered or not. The vinegar may be used in solid (such as a dry powder) or as a liquid. Acetic acid obtained using fermentation methods known in the art are also included herein.

The acetic acid may be used as a liquid or may be used as a powder. The acetic acid may be dried using such techniques known in the art to provide an acetic acid rich powder.

For example, vinegar (such as buffered vinegar or non-buffered vinegar) may be a source of acetic acid. Vinegar (such as buffered vinegar or non-buffered vinegar) may be present in element (II) of the composition in an amount from about 10% w/w to about 99% w/w, such as from about 20% w/w to about 90% w/w, such as from about 30% w/w to about 80% w/w, such as from about 20% w/w to about 60% w/w, such as about 28% w/w, or such as bout 52% w/w, or about 70% w/W.

The vinegar (such as buffered vinegar or non-buffered vinegar) may be dried by any method know in the art so as to obtain an acetic rich powder containing at least 5% w/w, such as at least 10%, at least 15%, 20%, 25%, 30%, 40%, 50%, 60% such as at least 80% acetic acid.

In certain embodiments of the products, methods or process of the invention, the concentration of carnosic acid in the final product (such as a meat product like cocked ham, fish or to a meat analogue product) is from about 5 ppm, 10 ppm, 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 2 ppm, 5 ppm, 10 ppm, 15 ppm, 20 ppm, 30 ppm, 40 ppm, 50 ppm, 60 ppm, 70 ppm, 80 ppm, 90 ppm, 100 ppm, to about 3%, 2%, 1% (10000 ppm), 3000 ppm, 2000 ppm, 1000 ppm, 800 ppm, 600 ppm, 500 ppm, 400 ppm, 300 ppm to 200 ppm w/w, such as 5 ppm to 100 ppm. In one embodiment, the ratio between carnosic acid and carnosol is from 40:1 to 5:1, such as 30:1, 20:1, 10:1 or 5:1.

In certain embodiments of the methods or process of the invention, the concentration of ascorbic acid in the final product (such as a meat, fish or to a meat analogue product) is from about 12 ppm, 15 ppm, 20 ppm, 30 ppm, 40 ppm, 50 ppm, 60 ppm, 70 ppm, 80 ppm, 90 ppm, 100 ppm, 150 ppm to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm, in respect to the final weight of the product.

In certain embodiments of the methods or process of the invention, the concentration of acetic acid in the final product (such as a meat, fish or to a meat analogue product) is from about 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm, such as from 50 ppm to 1000 ppm, such as 500 ppm in respect to the final weight of the product.

In certain embodiments, the concentration of carnosic acid in the final product (such as a meat, fish or to a meat analogue product) is from about 5 ppm, 10 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30 ppm, 40 ppm, 50 ppm, 60 ppm, 70 ppm, 80 ppm, 90 ppm, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, the concentration of ascorbic acid in the final product is from about 12 ppm, 15 ppm, 20 ppm, 30 ppm, 40 ppm, 50 ppm, 60 ppm, 70 ppm, 80 ppm, 90 ppm, 100 ppm, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as from 50 ppm to 1000 ppm; and/or the concentration of carnosol in the final product is from about 5 ppm, 10 ppm, 15 ppm, 20 ppm, 30 ppm, 40 ppm, 50 ppm, 60 ppm, 70 ppm, 80 ppm, 90 ppm, 100 pp, to about 6%, 5%, 4%, 4%, 3%, 2%, 1% (10000 ppm), 9000 ppm, 8000 ppm, 7000 ppm, 6000 ppm, 5000 ppm, 4000 ppm, 3000 ppm, 2000 ppm, 1000 ppm, 800 ppm, 600 ppm, 500 ppm, 400 ppm, 300 ppm to 200 ppm w/w, such as 5 ppm to 100 ppm, in respect to the final weight of the product.

For example, the anti-botulinum compositions of the invention may be present in the product in an amount of from about 0.1 g/kg to about 20 g/kg, such as from about 0.5 g/kg to about 15 g/kg, such as from about 0.5 g/kg to about 5 g/kg, such as 1 g/kg to about 15 g/kg, such as from about 0.5 to about 15 g/kg, such as 3 g/kg, 5 g/kg and 10 g/kg.

The ratio between acetic acid and ascorbic acid may be from 95:3 to 20:60, such as 90, 80, 70, 60, 50, 40, 30, 20:3, 5, 10, 20, 30, 40, 50 or 60, such as from 80:10 to 80:20, such as 71:24 to about 35:56, such as 80:15 or 30:60 or such as 77:17.

The ratio between ascorbic acid and the at least one phenolic diterpene (such as carnosic acid and carnosol) may be from 3:2 to 60:20, such as from 3, 5, 10, 20, 30, 40, 50, or 60:2, 5, 10 or 20, such as 15:5 or 60:10, such as 24:5 to about 56:8, such 17:6.

The ratio between acetic acid, ascorbic acid and the at least one phenolic diterpene (such asaronic acid and carnosol) may be from 95:3:2 to 20:60:20, such as 80:15:5 or 30:60:10, such as 71:24:5 to about 35:56:8, such as 77:17:6.

In certain embodiments, the Lamiaceae extract (such as rosemary and/or salvia extract) is added to the product so as to provide from 5 ppm to 1%, such as from 5 ppm to 200 ppm, such as from 10 ppm to 100 ppm, such as about 40 ppm of at least one phenolic diterpene in respect to the final weight of the product, ascorbic acid is added to the product so as to provide a final concentration in the product of from 10 ppm to 1%, such as from 50 ppm to 500 ppm such as from 100 ppm to 200 ppm, such as 110 μm in respect to the final weight of the product, and acetic acid is added to the product so as to provide a final concentration in the product of from 10 ppm to 1%, such as from 100 ppm to 1000 ppm, such as 500 ppm in respect to the final weight of the product.

In certain embodiments, at least one phenolic diterpene is added to the product so as to obtain a concentration in the final product of from 5 ppm to 1%, such as from 5 ppm to 200 ppm, such as from 10 ppm to 100 ppm, such as about 40 ppm of at least one phenolic diterpene in respect to the final weight of the product, ascorbic acid is added to the product so as to provide a final concentration in the product of from 10 ppm to 1%, such as from 50 ppm to 500 ppm such as from 100 to 200 ppm, such as 110 μm in respect to the final weight of the product, and acetic acid is added to the product so as to provide a final concentration in the product of from 10 ppm to 1%, such as from 100 ppm to 1000 ppm, such as 500 ppm in respect to the final weight of the product.

In certain embodiments, the meat product is essentially free of nitrite and nitrate

In certain embodiments the meat product has less than 250 ppm of nitrite and/or nitrate.

“Essentially free of nitrite and nitrate” means in the present invention that no external sources of Nitrite and/or nitrate are added to the final product. For example, the final product preferably has less than 100 ppm, such as less than 50 ppm, such as less than 10 ppm, such as less than 5 ppm of Nitrite and/or nitrate, such as 0 ppm
capable of controlling microbial growth and provide a red or pink color to a meat product that is stable to heat and/or low pH.

In certain embodiments, the ratio between component (I) and (II) is within the range of 1:4 to 2:5.

In certain embodiments, the curing aid is added to the product (such as a meat product) in an amount ranging from 0.2% to 1% by weight, such as 0.5% by weight.

In certain embodiments, controlling microbial growth includes preventing and/or inhibiting the outgrowth of Clostridium, of preventing and/or inhibiting the sporulation of Clostridium, of preventing and/or inhibiting the germination of spores of Clostridium and/or of preventing and/or inhibiting the production of Clostridium toxins in a product and preventing and/or inhibiting the outgrowth Listeria monocytogenes.

### Kit II

The present invention also relates to a kit comprising the different elements of the curing aid Composition of the invention separately i.e. component (I) and component (II) as described previously herein, and optionally instructions on how to mix, prepare and/or use said ingredients. In certain embodiments, the kit comprises the elements already mixed and ready to use (for example as a blend) and optionally instructions of how to use said ingredients. In certain embodiments, the kit comprises other colors such as yellow or red colors.

### Method for Making a Meat Product

The present invention is also related to a method of making consumable product (such as a meat product) comprising the steps of adding a stabilized dye composition of the invention to a consumable (such as a meat product) in an amount capable to provide a red or pink color to the meat product that is stable to heat and/or low pH.

The present invention is also related to a method of making consumable product (such as a meat product) comprising the steps of adding a curing aid composition according to the invention to a consumable (such as a meat product) in an amount capable to controlling microbial growth and provide a red or pink color to the meat product that is stable to heat and/or low pH.

The curing aid composition of the invention may be added as a ready to use blend or as separate elements of the curing aid composition of the invention (such as the elements of the kit of the invention)

The consumable product or food product (such as a food or beverage), packaged or not, of the present invention may be essentially free of nitrite and nitrate. In certain embodiments, the concentration of the nitrite and nitrate salts in the product (such as a food or beverage), packaged or not, of the present invention, is preferably less than 250 ppm, more preferably less than 200 ppm, even more preferably less than 150 ppm, and most preferably 0 ppm.

In certain embodiments, the meat product is essentially free of nitrite and nitrate

In certain embodiments the meat product has less than 250 ppm of nitrite and/or nitrate

In the present invention, the food may be cooked.

In certain embodiments the meat product is cooked meat product such as cooked ham or sausages (hot dogs).

It is clear for the person skilled in the art that any other food grade products that are used for the preparation of said meat products can be used. For example, in the case of cocked ham, other products, like salts and polyphosphates may be used.

In certain embodiments, the food product may have been subjected to a temperature of 40° C. or above for at least 10 minutes. The food product may have been subjected to a constant temperature for at least 10 minutes, or at least 1 hour, at least 10 hours, at least 20 hours; or may be subjected to increasing temperatures for several time periods. For example, the food product may be subjected to a temperature of 50° C. during 20 min, then at 55° C. during about 10 min, then at 74° C. during about 23 min and finally cooled until 10° C. during 5 min. The relative humidity during the heating process may be from about 10% relative humidity to about 99% of relative humidity. In a preferred embodiment, the food product (such as emulsified sausages like Frankfurter or hot dogs, cervelats etc) may be subjected to a temperature of about 50° C. during about 20 min (at a 99% relative humidity), then 55° C. during about 10 min, 74° C. during about 23 min and finally cooled until 10° C. during 5 min (at 10% relative humidity). In another embodiment the temperature may be of 80° C. and the time of heating may be up to 15-16 hours (such as for cooked ham).

Typically, the food product may have a fat content of from about 1% to about 60%, or from 5% to about 50% by weight of the product, such as from about 10% to about 40% by weight or from about 20% to about 30%.

Typically, the food product may have a pH of from about 4 to about 10, or from about 5 to about 8, or from about 6 to about 7, such as about 6.5. pH is measured by standard techniques such as a pHmeter.

The product (such as a food or beverage), packaged or not, may have a pH in the range of about 4.6 to about 8.5, such as 5.8 to about 6.2. The product (such as a food or beverage), packaged or not, may have a salt content less than about 5.0% by weight.

The product (such as a food or beverage), packaged or not, may have a pH in the range of about 3 to about 6, such as 4.5 to about 5.5.

### Color Evaluation

The colour compositions and the food products of the present disclosure can be analyzed with a spectrophotometer, and CIELAB L*a*b* values can be calculated from the spectral data, as described in greater detail below. The L*a*b* values provide a means of representing colour characteristics and assessing the magnitude of difference between two colours. The L*a*b* values also provide a means of representing colour characteristics and assessing the magnitude of difference between two colours not only of solutions, but also of products. Measurements of colour compositions and products in solid form are accomplished using reflectance measurements from the surface of the product.

For example, L*a*b* values consist of a set of coordinate values defined in a three-dimensional Cartesian coordinate system. L* is the lightness coordinate and provides a scale of lightness from black (0 L* units) to white (100 L* units) on a vertical axis. a* and b* are coordinates related to both hue and chroma. a* provides a scale for greenness (−a* units) to redness (+a* units), with neutral at the center point (0 a* units), on a horizontal axis; b* provides a scale for blueness (−b* units) to yellowness (+b* units), with neutral at the center point (0 b* units), on a second horizontal axis perpendicular to the first horizontal axis. The three axes cross where L* has a value of 50 and a and b* are both zero.

ΔE is a measure of the magnitude of total color difference between two colors represented in CIELAB L*a*b* color space. It has been reported that an experienced color observer cannot distinguish any difference between two colors when the ΔE is about 2.3 or less. The ΔE of two different colors with L*a*b* values, L*1a*1b*1 and L*2a*2b*2, is calculated using Equation 1:

$$Δ {E}_{ab}^{*} = \sqrt{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}} \qquad Equation 1$$

The present invention is further illustrated by means of the following non-limiting examples.

### EXAMPLES

### Example 1

### Materials and Methods

High strength Beetroot extract (water soluble powder, PWS):

Extract was prepared by water extraction, extract was purified then via Adsorption-Desorption column, sterilized the spray dried, final content of betanin is higher than 15%.
Market beetroot: standard market beetroot was use to compare performance of new formulation, this market reference has (4.8-5.2% of betanin) and ascorbic acid.
Citric acid (water soluble powder, PWS): citric acid monohydrate was used in current formulation (citric acid content is >99.5%)
Ascorbic acid (water soluble powder, PWS): ascorbic acid was used in current formulation (ascorbic acid content is >99%).
Sodium citrate (water soluble powder, PWS): sodium citrate dihydrate was used in our formulation (purity >99%)

Formulation 1: liquid stable formulation of red beet: Ingredient in table 1 were mixed for 20 min upon stirring.

TABLE 1

| Ingredients | |
|---|---|
| (beetroot, 15% betanin) | 5 |
| Ascorbic acid | 20 |
| citric acid | 2 |
| water | 68.88 |
| Potassium sorbate | 0.12 |
| Sodium citrate | 4 |
| total | 100 |

Formulation 2: stable powder formulation of red beet

Formulation was made via simple powder blending; composition Is detailed in the table 2:

TABLE 2

| Ingredients | % |
|---|---|
| Beetroot, 15% betanin | 16 |
| Maltodextrin | 5 |
| Ascorbic acid | 61 |
| citric acid | 6 |
| sodium citrate | 12 |

TABLE 3
Bakery application: Cupcakes recipe

| Ingredients | % |
|---|---|
| flour | 31.2 |
| sugar | 22 |
| oil | 10 |
| milk | 20.8 |
| baking powder | 1 |
| eggs | 16.67 |

### Example 1: Improvement of Betanin Retention after Heat Treatment in pH 6 Buffer Model System

Sample 1A: 0.1 g of formulation 1 was dissolved in 100 ml of phosphate buffer pH6, Sample 1B (control): 0.16 g of commercial red beet formulation (stabilized with ascorbic acid) was dissolved in 100 ml of phosphate buffer pH6.

Samples 1A and 1B (control) were heated at 70° C. at 40 min. Initial colour of samples was recorded before and after heating

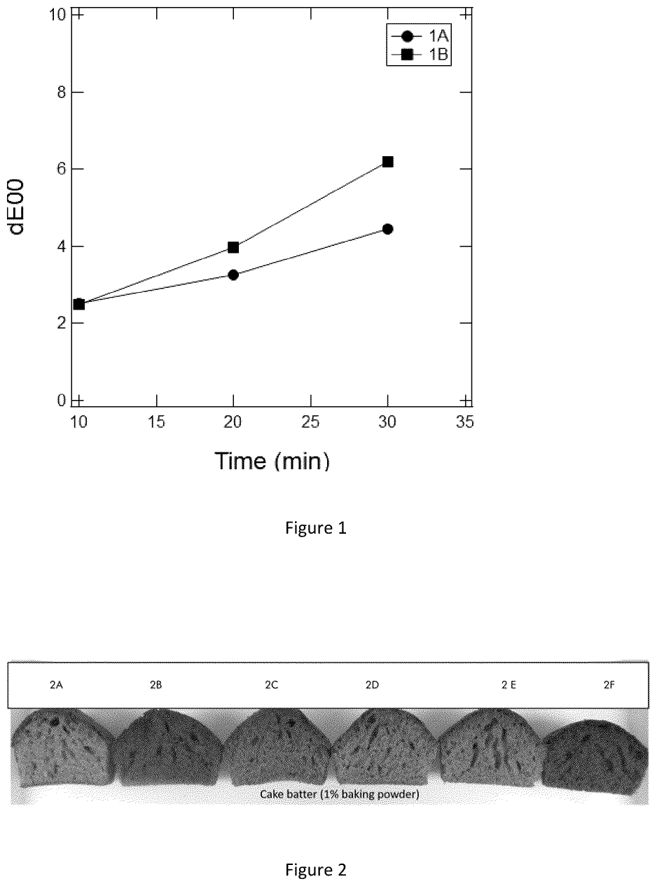

As shown in FIG. 1, formulation 1A showed lower dE2000 (colour deviation) this suggests that formulation 1A allowed better retention of betanin.

### Example 2: Improvement of Heat Stability in Bakery Application Synergetic Effect of Ascorbic Acid, Citric Acid and Sodium Citrate

In order to Investigate Impact of different stabilizer, we evaluated the heat stability upon using the different Ingredients separately according to table 4:

TABLE 4

| Example | 2A | 2B | 2C | 2D | 2E | 2F |
|---|---|---|---|---|---|---|
| Composition | Control: | 0.1028 g | 0.1028 g | 0.1028 g | 0.32 g | Formulation 1 |
| | 0.1028 g | red beet | red beet | red beet | commercial | |
| | red beet | (15%) + | (15%) + | (15%) + | red beet | |
| | extract | 0.4 g | 0.04 g | 0.08 g | stabilized | |
| | (15% | ascorbic | Citric | sodium | with Ascorbic | |
| | betanin) | acid | acid | citrate | acid | |
| dosage in | 0.1028 | 0.4 | 0.04 | 0.08 | 0.32 | 2 |
| bakery(%) | | | | | | |
| E(1%) | 182.63 | 182.63 | 182.63 | 182.63 | 58.26 | 9.39 |

Different formulations were used to colour bakery batters then cakes were baked at 170° C. during 20 min.

We recorded both the Initial Lab value of cakes batters and L,a, b after baking, table 5 shows the evolution of colour before and after baking.

TABLE 5
NH: Samples without heating.

| samples | L*(D65) | a*(D65) | b*(D65) | C*(D65) | h(D65) | dL*(D65) | dC*(D65) | dH*(D65) | dE00(D65) |
|---|---|---|---|---|---|---|---|---|---|
| 2A - | 35.44 | 35.23 | 4.76 | 35.55 | 7.69 | — | — | — | — |
| NH | | | | | | | | | |
| 2A- | 57.45 | 26.12 | 48.8 | 55.35 | 61.84 | 22.01 | 19.8 | 40.38 | 34.74 |
| 170° C.- | | | | | | | | | |
| 20 min | | | | | | | | | |
| 2B - NH | 35.68 | 37.09 | 5.34 | 37.47 | 8.2 | — | — | — | — |
| 2B- | 45.77 | 40.3 | 28.76 | 49.51 | 35.51 | 10.1 | 12.04 | 20.34 | 16.05 |
| 170° C.- | | | | | | | | | |
| 20 min | | | | | | | | | |
| 2C - NH | 35.47 | 35.77 | 5.21 | 36.15 | 8.29 | — | — | — | — |
| 2C- | 52.09 | 33.78 | 38.15 | 50.96 | 48.48 | 16.62 | 14.81 | 29.49 | 25.09 |
| 170° C.- | | | | | | | | | |
| 20 min | | | | | | | | | |
| 2D - NH | 35.18 | 35.05 | 4.71 | 35.36 | 7.65 | — | — | — | — |
| 2D- | 56.74 | 26.91 | 44.51 | 52.01 | 58.84 | 21.56 | 16.65 | 37.06 | 32.66 |
| 170° C.- | | | | | | | | | |
| 20 min | | | | | | | | | |
| 2^{E} - NH | 34.72 | 34.48 | 5.14 | 34.87 | 8.47 | — | — | — | — |
| 2E- | 53.21 | 29.38 | 41.38 | 50.75 | 54.63 | 18.49 | 15.89 | 32.98 | 28.37 |
| 170° C.- | | | | | | | | | |
| 20 min | | | | | | | | | |
| 2F - NH | 35.73 | 37.44 | 6.75 | 38.04 | 10.22 | — | — | — | — |
| 2F- | 41.68 | 42.58 | 23.18 | 48.49 | 28.57 | 5.95 | 10.44 | 13.7 | 10.46 |
| 170° C.- | | | | | | | | | |
| 20 min | | | | | | | | | |

As shown in table 5, 2F (Inventive Formulation 1) showed more intense red colour expression after baking if compare with the other control samples. This is proving that formulation 1 (2F) allows a good retention of the color provide by the betanin. This result Is also emphasized by the values of dE2000, since 2F sample has the lowest colour deviation against the non-baked batters (see FIG. 2)

### Example 3: Synergetic Effect of Ascorbic Acid, Citric Acid and Sodium Citrate on Betanin Stability in Model pH6 Buffer System

In order to Investigate Impact of different stabilizer, we evaluated the heat stability upon using the different Ingredients separately according to table below:

TABLE 6

| Example | 3A | 3B | 3C | 3D | 3E | 3F |
|---|---|---|---|---|---|---|
| Composition | 0.1 g | 0.005 g | 0.005 g | 0.005 g | 0.005 g | 0.02 g |
| | Formulation 1 | red beet | red beet | red beet | red beet | market red |
| | 99.9 g | (15% | (15%) | (15%) | (15%) | beet (5% |
| | PH 6 | betanin) | 0.02 g | 0.002 g | 0.004 g | betanin) |
| | phosphate | 99.9 g | ascorbic | citric | sodium | 0.004 g |
| | buffer | PH 6 | acid | acid | citrate | sodium |
| | | phosphate | 99.97 | 99.93 g | 99.91 g | citrate |
| | | buffer | PH 6 | PH 6 | PH 6 | 99.91 g |
| | | | phosphate | phosphate | phosphate | PH 6 |
| | | | buffer | buffer | buffer | phosphate |
| | | | | | | buffer |

As shown in table 6, 2F (Inventive Formulation 1) showed more intense red colour expression after baking suggesting that Inventive Formulation 1 allows a good retention of betanin. This result Is also emphasized by the values of dE2000: 2F sample has the lowest colour deviation against the non-baked batters.

Different samples were submitted to thermal stress at 70° C. for 30 min

We recorded initial absorbance at maximum absorption wavelength and measure the absorbance after heating; color retention Is given by this equation:

$$R = \frac{A ( after heating )}{A before heating ( t 0 )} * 100$$

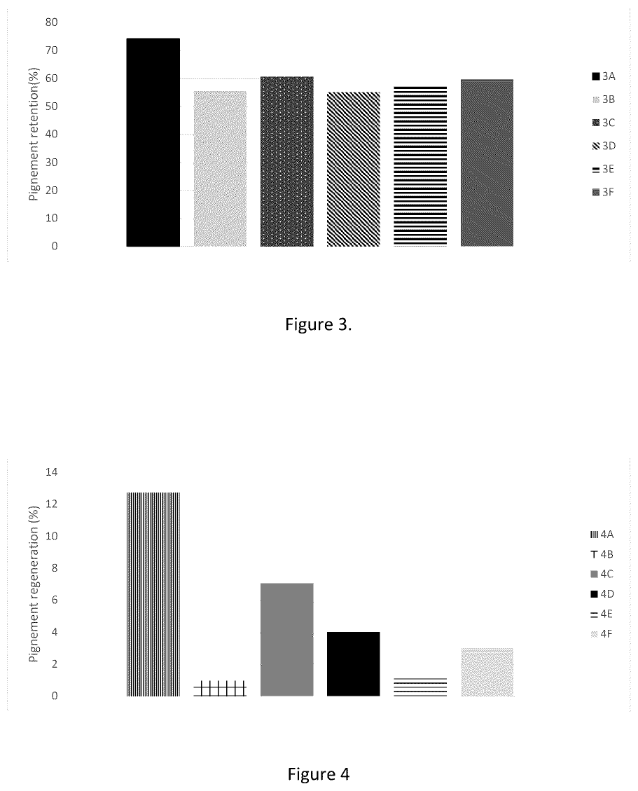

As it can be seen in FIG. 3, the inventive formulation 1 (3A) exhibited the highest retention percentage of betanin due to higher stability of this formulation, this finding suggests that there is a non-expected synergetic effect between ascorbic, citric acid and sodium citrate making the stabilization of betanin more effective.

### Example 4: Improvement of Betanin Regeneration after Heat Treatment in pH 6 Buffer Model System

In order to study the improvement of betanin regeneration after heat treatment, we screened the impact of different stabilizer used in previous example (table 6).

TABLE 7

| Example | 4A | 4B | 4C | 4D | 4E | 4F |
|---|---|---|---|---|---|---|
| Composition | 0.1 g | 0.005 g | 0.005 g | 0.005 g | 0.005 g | 0.02 g |
| | Formulation 1 | red beet | red beet | red beet | red beet | market red |
| | 99.9 g | (15% | (15%) | (15%) | (15%) | beet (5% |
| | Ph 6 | betanin) | 0.02 g | 0.002 g | 0.004 g | betanin) |
| | phosphate | 99.9 g | ascorbic | ascorbic | sodium | 0.004 g |
| | buffer | Ph 6 | acid | acid | citrate | sodium |
| | | phosphate | 99.97 | 99.93 g | 99.91 g | citrate |
| | | buffer | PH 6 | PH 6 | PH 6 | 99.91 g |
| | | | phosphate | phosphate | phosphate | PH 6 |
| | | | buffer | buffer | buffer | phosphate |
| | | | | | | buffer |

Different heated samples from examples 3 stored at 4° C. for 12 h

Betanin regeneration was calculated by this equation:

$$R = \frac{A ( after 12 h at 4 ° C . )}{A after heating ( example 3 )} * 100$$

FIG. 4 shows the regeneration of the color in the sample with the inventive formulation against other formulation using ascorbic acid, citric acid, sodium citrate separately. Surprisingly sample 4A showed the highest pigment regeneration, this suggested that without bond to any theory the new formulation accelerated the kinetics of condensation of betalamic acid and cyclodopa-S-o-glycoside.

### Example 5: Improved Performance of Stabilized Beetroot in Cooked and Fried Matrix (Snack)

Table 8. Formulation 2. stable powder formulation of red beet

TABLE 8
Formulation 2. stable powder formulation of red beet

| Ingredients | |
|---|---|
| Beetroot, 15% betanin | 16 |
| Maltodextrin | 5 |
| Ascorbic acid | 61 |
| citric acid | 6 |
| sodium citrate | 12 |

Snack application recipe:

Base was prepared using 50% corn semolina+50% water (adjusted to pH 7 using sodium bicarbonate), colour (red beet) is diluted first in small amount of water then added to the base Base was cooked at 120° C. for 40 min, extrusion and pressurization could be used instead as well (parameter: T: 125° C. 30 min)

Extruded or cooked base is then fried at 200° C. for 1 min.

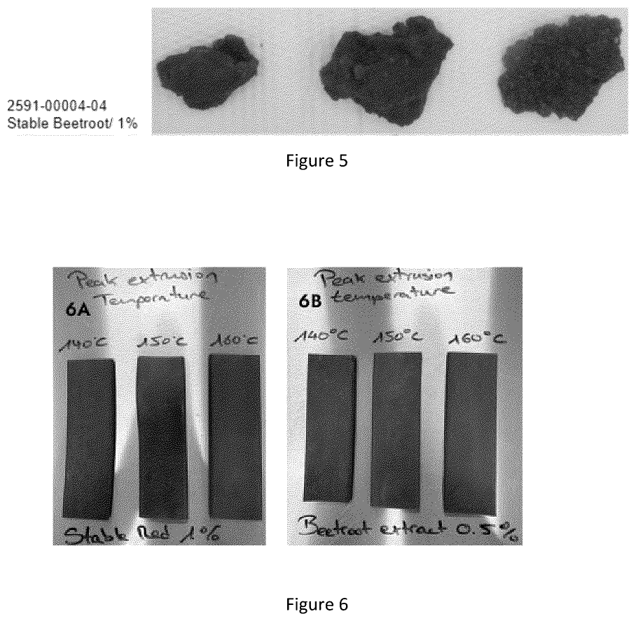

Formulation 2 was incorporated in snack recipe (described above in material section) at 1% of dose level. Mixture was cooked at 120° C. for 40° C. and then fried at 200° C. for 1 min. Surprisingly red colour shade of formulation 2 was maintained after this strong heat processing which show the improved heat resistance of our new formulation (FIG. 5)

### Example 6: Improved Performance of Stabilized Beetroot in Extruded Protein Base

### High Moisture Extrusion Recipe and Process.

Recipe: Protein base: ADM Arcon SM Soy Protein Powder.
Base Formulation: 37% Soy Protein+63% Water
Colours added on top of base formulation.
Extrusion devise: Bühler 30 mm Pilot-scale extruder (BC™).
Heat processing: 3 tests were performed 140° C., 150° C. and 160° C.

TABLE 9
Formulation 2 (stabilized beetroot)

| Ingredients | |
|---|---|
| Beetroot, 15% betanin | 16 |
| Maltodextrin | 5 |
| Ascorbic acid | 61 |
| citric acid | 6 |
| sodium citrate | 12 |

Sample 6 A: Formulation 2 was incorporated at 1% in the protein base as described below and extruded at 3 different Temperatures: 140° C., 150° C. and 160° C., L,a,b were recorded after the extrusion to evaluate colour retention

Sample 6 B: Market beetroot was incorporated at 0.5% (equivalent betanin content with 1% of formulation 2) in the protein base as described below and extruded at 3 different Temperatures: 140° C., 150° C. and 160° C.

As shown in table below 9 a values after extrusion for all temperature show that new stable beetroot (6A) is redder (higher a values of a) than 6B (standard beetroot). This is showing a better stability even when extruded at high temperatures. This result is also showcased in FIG. 6 (photos of extruded samples 6A-formulation of the invention and 6B-standard beetroot)

TABLE 10

| samples | L | a | b |
|---|---|---|---|
| 6A-140° C. | 35.57 | 25.61 | 11.30 |
| 6B-140° C. | 38.98 | 20.35 | 15.94 |
| 6A-150° C. | 39.08 | 25.11 | 16.18 |
| 6B-150° C. | 40.15 | 20.02 | 19.15 |
| 6A-160° C. | 38.55 | 26.18 | 16.19 |
| 6B-160° C. | 41.85 | 18.81 | 20.81 |

### Example 7. Cooked Ham

a. Brine Preparation.

Brine is prepared with tap water at room temperature, following the composition (see table 10).

TABLE 11
Brine composition

| | Composition | Qty in final | |
|---|---|---|---|
| Ingredients | of brine % | meat product | |
| Salt NaCl | 19.8% | 18 | g/kg |
| Sugar (Dextrose) | 5.5% | 5 | g/kg |
| Erythorbate, sodium or | 0.55% | 0.5 | g/kg |
| potassium ascorbate | | | |
| Polyphosphates s98 | 2.8% | 3.6 | g/kg |
| Water | 74.15% | | |

When extracts are added into the brine, they are incorporated first into water prior to the addition of the other ingredients. Composition of blend tested are presented in table 12.

TABLE 12
Preservation block composition

| | | Active | Actives in | qty |
|---|---|---|---|---|
| | | target in | meat when | needed |
| | | blend | dosed at 0.5% | in blend |
| Name | Specifications | (%) | (%) | (%) |
| buffered | Acetic acid 10.0-12.0% - | 10 | 0.0500 | 35.21 |
| vinegar | HPLC | | | |
| Sage | Carnosic Acid + Carnosol | 0.9 | 0.0045 | 2.82 |
| extract | 0.80-1.50% - HPLC | | | |
| Acerola | Ascorbic acid 2.0-3.0% - | 2.5 | 0.0125 | 7.54 |
| powder | HPLC | | | |
| Arabic | | | | 54.43 |
| gum | | | | |

TABLE 13
Formulation 3: stable powder formulation
of red beet for meat application.

| Ingredients | |
|---|---|
| Beetroot, 5% betanin | 20 |
| Maltodextrin | 2 |
| Ascorbic acid | 60 |
| citric acid | 6 |
| sodium citrate | 12 |

Preservation block will be used between 0.3-1.0% in meat products specially 0.5 or 0.75%, Color Block (Formulation 3 as defined in table 13) will be used between 0.1-0.5% in meat products, especially at 0.17%.

b. Cooked Ham Process.

Standard process of cooked ham preparation was followed. After a step of massaging, meat samples are injected between 10 to 20% (15%) with the brine. Tumbling was performed following the sequence below:
15-25 min at 5-9 rpm under vacuum or not vacuum (17.5 min at 7 rpm not under vacuum)
16 h alternate=5 min rotation at 7 rpm/15 min break
14 h alternate=5 min rotation at 8 rpm/15 min break

Muscles were netted together and molded under vacuum before cooking and cooling down steps. Temperature threshold of 2 h at 50° C., then 1 h30 at 60° C. and finally 66° C. to 64.5° C. at core. After chilling steps, cooked ham were sliced and stored into modified atmosphere packaging N2/CO2 80/20 or 70/30 v/v at 4° C. to 8° C.

c. Color Measurements.

After 10 days, each pack of cooked ham was opened. Colors measurements were performed in triplicates right after the opening and after 4 h exposed at room temperature. The letters L*, a* and b* represent each of the three values the CIELAB color space uses to measure objective color and calculate color differences. L* represents lightness from black to white on a scale of zero to 100, while a* and b* represent chromaticity with no specific numeric limits. Negative a* corresponds with green, positive a* corresponds with red, negative b* corresponds with blue and positive b* corresponds with yellow.

d. Results Example 7.

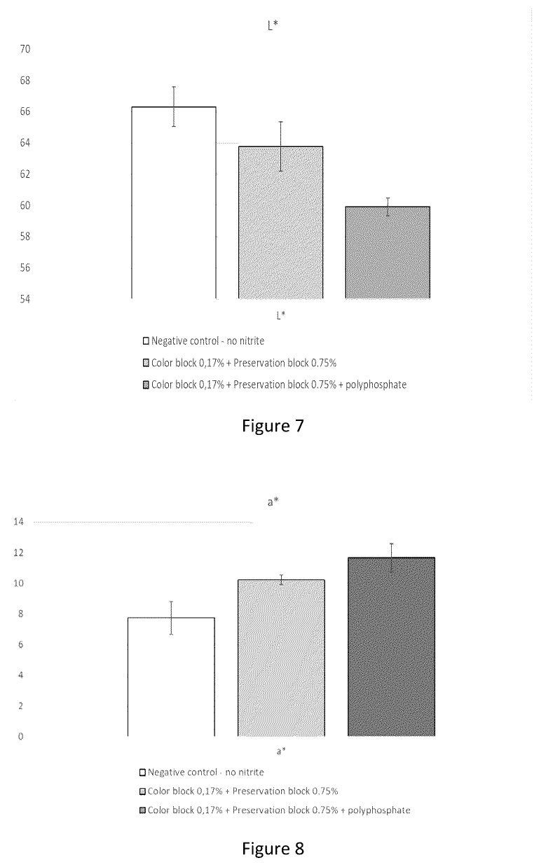

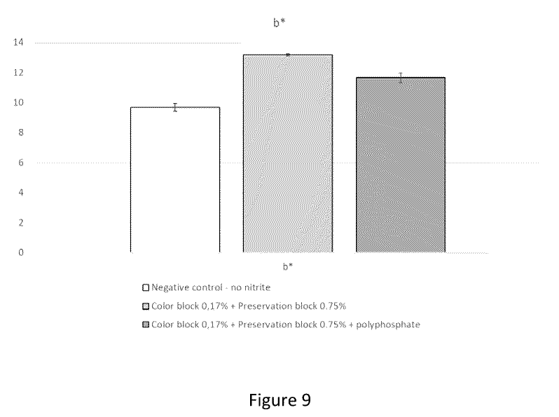

Color measurements of cooked ham right after opening. L* is shown on FIG. 7, a* is shown FIG. 8, b* is shown on FIG. 9.

1. A dye composition comprising components A) and B), wherein A) is one or more dyes comprising a Betalain and B) comprises one or more of citric acid, ascorbic acid, malic acid and ethylenediaminetetraacetic acid; and at least one salt.

2. The composition according to claim 1, wherein Betalain is selected from a Betacyanin, and/or a Betaxanthin.

3. The composition according to claim 1, wherein A) comprises one or more plant extracts and/or plant concentrates obtained from one or more of: beet roots (Beta vulgaris L.), amaranth (Amaranthus sp.), pitahaya, Opuntia sp., Eulychnia sp. and Hylocereus sp., dragon fruits, colored Swiss chard (B. vulgaris L. ssp. cicla), Celosia argentea L., Bougainvillea sp. ulluco (Ullucus tuberosus Caldas) or bloodberries (berries of Rivina humilis L.) and/or pigments produced via a microorganism.

4. The composition according to claim 1, wherein the at least one salt comprises a salt of citric acid, ascorbic acid, malic acid, ethylenediaminetetraacetic acid, or mixtures thereof.

5. The composition according to claim 1, wherein the acid is citric acid and ascorbic acid.

6. The composition according to claim 1, wherein the at least one salt comprises citrate salts, ascorbate salts or mixtures thereof.

7. The composition according to claim 1, wherein the weight ratio of betalains and component B) is of from about 0.05:50 to about 50:0.1.

8. The composition according to claim 1, wherein if two acids are used the weight ratio of first acid to second acid is of from about 1:30 to about 30:1.

9. The composition according to claim 1, wherein the weight ratio of one or more acids to the at least one salt is of from about 1:10 to about 10:1.

10. The composition according to claim 1, wherein B) is citric acid, ascorbic acid and sodium citrate.

11. The composition according to claim 10, wherein the weight ratio between citric acid, ascorbic acid and sodium citrate is 1:2:10

12. The composition according to claim 1 that is stable to heat.

13. The composition according to claim 1 further comprising (II) one or more antioxidants and/or one or more antimicrobials.

14. The composition according to claim 13, wherein the antioxidant and/or antimicrobial comprises one or more of Lamiaceae extract, ascorbic acid, acetic acid, green tea, organic acids, yeast extracts, pomegranate extract, Artichokes extract, Olive extract, and green coffee extract.

15. The composition according to claim 13, wherein the antioxidant and/or antimicrobial comprises a Lamiaceae extract, acerola juice or dry juice comprising ascorbic acid and vinegar.

16. A method for obtaining a thermally stable dye comprising Betalains, the method comprising the steps of
i. providing one or more dyes comprising a Betalain,
ii. providing one or more of citric acid, ascorbic acid, malic acid and/or ethylenediaminetetraacetic acid, and at least one salt, and
iii. mixing the ingredients in steps i and ii.

17. A stabilized dye comprising Betalains obtained by the method of claim 16.

18. (canceled)

19. A consumable, a pharmaceutical, a cosmeceutical, a nutraceutical or cosmetic product comprising a composition according to claim 1.

20. The consumable, a pharmaceutical, a cosmeceutical, a nutraceutical or cosmetic product according to claim 19, wherein the product is treated with a heating process and the color provided by the dye composition is stable after said heating process.

21. (canceled)

22. (canceled)

23. A method of making a Nitrite-free meat product that has the properties of a meat product that has been cured with Nitrites, comprising the step of adding a dye composition according to claim 1.
